(19) United States
(12) Patent Application Publication
(10) Pub. No.: US 2012/0223164 A1
(43) Pub. Date: Sep. 6, 2012

(54) NOZZLE ASSEMBLY FOR AN INJECTION VALVE AND INJECTION VALVE

(76) Inventors: Junmei Shi, Regensburg (DE); Milos Tichy, Regensburg (DE)

(21) Appl. No.: 13/395,933

(22) PCT Filed: Sep. 13, 2010
(86) PCT No.: PCT/EP2010/063409

§ 371 Date: May 24, 2012

(30) Foreign Application Priority Data
Sep. 14, 2009 (DE) 10 2009 041 028.7
Nov. 24, 2009 (DE) 10 2009 054 399.6

(51) Int. Cl. B05B 1/30

(52) U.S. Cl. 239/584

(57) ABSTRACT

A nozzle assembly for an injection valve includes having a nozzle body recess and at least one injection opening, the nozzle body recess being hydraulically coupled to a high-pressure circuit of a fluid, and the injection opening being hydraulically coupled to the nozzle body recess. The nozzle assembly further includes at least one nozzle needle axially movable in the nozzle body recess, and having a central axis and a needle tip that interacts with a wall of the nozzle body recess such that in a closed position, the nozzle needle prevents a fluid flow through the injection opening(s), and in an open position, permits the fluid flow through the injection opening(s). Turbulence elements including recesses and/or protrusions formed as microstructures are arranged on the needle tip and/or walls of the nozzle body recess. The turbulence elements generate a predefined intensity of turbulence of the fluid in the injection opening(s).

### CROSS-REFERENCE TO RELATED APPLICATIONS

This application is a U.S. National Stage Application of International Application No. PCT/EP2010/063409 filed Sep. 13, 2010, which designates the United States of America, and claims priority to German Application No. 10 2009 041 028.7 filed Sep. 14, 2009 and German Application No. 2009 054 399.6 filed Nov. 24, 2009, the contents of which are hereby incorporated by reference in their entirety.

### TECHNICAL FIELD

This disclosure relates to a nozzle assembly for an injection valve and to an injection valve having a nozzle assembly.

### BACKGROUND

Ever more stringent legal regulations with regard to the admissible pollutant emissions and fuel consumption of internal combustion engines arranged in motor vehicles make it necessary to implement various measures to reduce the pollutant emissions and fuel consumption. The formation of soot is highly dependent inter alia on the preparation of the air/fuel mixture in the respective cylinder of the internal combustion engine. One approach here is to obtain very good preparation of the air/fuel mixture and thereby reduce the pollutant emissions generated by of the internal combustion engine and the fuel consumption thereof.

Correspondingly improved mixture preparation can be achieved if the fuel is metered at a very high pressure. In the case of some diesel internal combustion engines, the fuel pressures are up to over 2000 bar, and in the case of some gasoline internal combustion engines, the fuel pressures are approximately 200 bar. Such high pressures place high demands on the material of the nozzle assembly, on the structure thereof and also on the injection valve as a whole. At the same time, the nozzle assembly must accommodate higher forces.

### SUMMARY

In one embodiment, a nozzle assembly for an injection valve includes a nozzle body and at least one nozzle needle. The nozzle body has a nozzle body recess and at least one injection opening, wherein the nozzle body recess can be hydraulically coupled to a high-pressure circuit of a fluid, and the injection opening is hydraulically coupled to the nozzle body recess. The at least one nozzle needle is arranged in an axially movable manner in the nozzle body recess and which has a central axis and a needle tip, wherein a sealing seat is formed on a wall of the nozzle body recess and a seat region is formed on the needle tip, and the seat region interacts with the sealing seat such that the nozzle needle, in a closed position, prevents a fluid flow through the at least one injection opening and, in an open position, permits the fluid flow through the at least one injection opening. Downstream of the sealing seat and of the seat region, turbulence elements including recesses and/or protrusions formed as microstructures are arranged at least on the needle tip and/or on at least one surface region of the nozzle body recess, in such a way that a predefined intensity of the turbulence of the fluid in the at least one injection opening can be generated by means of the turbulence elements.

In a further embodiment, the surface region is a wall of the nozzle body and/or a wall of the at least one injection opening. In a further embodiment, the recesses and/or protrusions are of annular design. In a further embodiment, the recesses and/or protrusions have a zig-zag shaped structure. In a further embodiment, the recesses and/or protrusions are parts of a predefined surface roughness of the needle tip and/or of the wall of the nozzle body recess and/or of the wall of the at least one injection opening. In a further embodiment, downstream of the sealing seat of the nozzle body recess is formed which is hydraulically coupled to the at least one injection opening, and wherein the surface region of the nozzle body recess of the portion of the nozzle body recess.

In a further embodiment, the portion of the nozzle body recess is formed as a blind hole, and the nozzle body has an edge or a transition portion between the portion formed as a blind hole and further portions of the nozzle body recess, and the recesses and/or protrusions are arranged in the region of the edge or of the transition portion of the nozzle body. In a further embodiment, the nozzle body has a further edge or a further transition portion between the portion of the nozzle body recess and the at least one injection opening, and the recesses and/or protrusions are arranged in the region of the further edge or of the further transition portion of the nozzle body. In a further embodiment, the recesses and/or protrusions formed as microstructures have a height or depth of at least approximately 3 μm. In a further embodiment, the recesses and/or protrusions formed as microstructures have a height or depth of at least approximately 18 μm. In a further embodiment, the nozzle assembly includes at least two injection openings, wherein at least one of the recesses and/or protrusions is assigned to each of the injection openings. In a further embodiment, in each case two of the recesses and/or protrusions are assigned to each of the injection openings.

In a further embodiment, the portion of the nozzle body recess is formed as a blind hole with a blind hole wall and a blind hole base, and the injection openings are arranged in the blind hole base, and in each case two of the recesses and/or protrusions are assigned to each of the injection openings, and one of said recesses and/or protrusions is arranged in the blind hole base, and the other of said recesses and/or protrusions is arranged in the blind hole wall. In a further embodiment, the recesses are of duct-like form and/or the protrusions are of rod-like form and extend in each case in a longitudinal direction, and wherein the longitudinal directions of the recesses and/or levations are tangents to the injection openings. In a further embodiment, the recesses and/or the protrusions are formed so as to be curved toward the injection openings.

In another embodiment, an injection valve includes a nozzle assembly and an actuator. The nozzle assembly includes a nozzle body and at least one nozzle needle. The nozzle body has a nozzle body recess and at least one injection opening, wherein the nozzle body recess can be hydraulically coupled to a high-pressure circuit of a fluid, and the injection opening is hydraulically coupled to the nozzle body recess. The at least one nozzle needle is arranged in an axially movable manner in the nozzle body recess and which has a central axis and a needle tip, wherein a sealing seat is formed on a wall of the nozzle body recess and a seat region is formed on the needle tip, and the seat region interacts with the sealing seat such that the nozzle needle, in a closed position, prevents a fluid flow through the at least one injection opening and, in an open position, permits the fluid flow through the at least one injection opening. Downstream of the sealing seat and of the seat region, recesses and/or protrusions formed as microstructures are arranged at least on the needle tip and/or on at least one surface region of the nozzle body recess, in such a way that a predefined intensity of the turbulence of the fluid in the at least one injection opening can be generated by means of the recesses and/or protrusions. The actuator is designed to act on the nozzle assembly.

### BRIEF DESCRIPTION OF THE DRAWINGS

Example embodiments will be explained in more detail below with reference to figures, in which:

FIG. 1 shows an injection valve in longitudinal section, according to certain embodiments.

FIG. 2 shows an enlarged illustration of a detail II from FIG. 1 in the region of a needle tip of a nozzle needle, according to certain embodiments.

FIG. 3 shows an enlarged illustration of recesses or protrusions (turbulence elements), according to certain embodiments.

FIG. 4 shows a further injection valve in longitudinal section, according to certain embodiments.

FIG. 5 shows an enlarged illustration of a detail V from FIG. 4 in the region of an injector body, according to certain embodiments.

FIG. 6 shows another example embodiment of an injector body with protrusions.

FIG. 7 shows another example embodiment of an injector body with protrusions.

FIG. 8 shows a diagrammatic illustration of the swirl formation at an injection opening, according to certain embodiments.

FIG. 9 shows an example embodiment of an injector body with recesses.

FIG. 10 shows another example embodiment of the injector body with recesses.

FIG. 11 shows another example embodiment of the injector body with recesses.

### DETAILED DESCRIPTION

Some embodiments provide a nozzle assembly and an injection valve which permit reliable and precise operation.

Certain embodiments provide a nozzle assembly for an injection valve, having a nozzle body which has a nozzle body recess with a wall and has at least one injection opening. The nozzle body recess can be hydraulically coupled to a high-pressure circuit of a fluid, and the injection opening is hydraulically coupled to the nozzle body recess. The nozzle assembly has at least one nozzle needle which is arranged in an axially movable manner in the nozzle body recess and which has a central axis and a needle tip. The needle tip interacts with a wall of the nozzle body recess in such a way that the nozzle needle, in a closed position, prevents a fluid flow through the at least one injection opening and, in an open position, permits a fluid flow through the at least one injection opening. Here, a sealing seat is formed on the wall of the nozzle body recess and a seat region is formed on the needle tip. These permit the interaction described above. According to certain embodiments, downstream of the sealing seat and of the seat region, turbulence elements including recesses and/or protrusions formed as microstructures are arranged at least on the needle tip and/or on at least one surface region of the nozzle body recess. A predefined intensity of the turbulence of the fluid in the at least one injection opening can be generated by means of the recesses and/or protrusions (turbulence elements).

The predefined intensity of the turbulence of the fluid refers to the intensity of the turbulence which, at a predefined pressure of the fluid, correlates with a desired distribution of the shear rate in the fluid and a desired formation of the size and distribution of turbulence vortices of the fluid. Said predefined intensity is in particular not defined by random unevennesses on the needle tip, in the wall of the nozzle body or in the wall of the at least one injection opening.

Said arrangement may have the advantage that a high level of intensity of the turbulence can be attained in particular in the at least one injection opening. It may thereby be possible to attain good swirl formation in the fluid. It may thereby be possible at the injection valve to attain a well-formed spray pattern with very small fluid droplets. Furthermore, in this way, the jet of the spray may attain a short length and a large width. Furthermore, a high mass flow of the fluid through the nozzle assembly of the injection valve may be attained.

In an advantageous embodiment, the at least one surface region is a part of the wall of the nozzle body and/or a part of the wall of the at least one injection opening.

In a further advantageous embodiment, the recesses and/or protrusions are of annular design. This may provide the advantage that such forms can be produced in a simple manner.

In a further advantageous embodiment, the recesses and/or protrusions have a zig-zag shaped structure. It may thereby be possible to attain a high intensity of the turbulence of the fluid in the at least one injection opening. Furthermore, the recesses and protrusions may be produced on the needle tip or on the injector body in a very simple manner.

In a further advantageous embodiment, the recesses and/or protrusions are parts of a predefined surface roughness of the needle tip and/or of the wall of the nozzle body recess and/or of the wall of the at least one injection opening. It may thereby be possible for a suitable surface roughness of the needle tip or of the injector body to be provided in a simple manner as early as during the production process.

In a further advantageous embodiment, downstream of the sealing seat, a portion of the nozzle body recess is formed which is hydraulically coupled to the at least one injection opening. Here, the surface region of the nozzle body recess is a wall of the portion of the nozzle body recess. Since the speed of the fluid may be particularly high in the portion of the nozzle body recess, the arrangement of the recesses and/or protrusions on the wall of the portion of the nozzle body recess may provide the advantage that the high intensity of the turbulence of the fluid can be attained in a particularly simple manner.

In a further advantageous embodiment, the portion of the nozzle body recess is formed as a blind hole. The nozzle body has an edge or a transition portion between the portion formed as a blind hole and further portions of the nozzle body recess. The recesses and/or protrusions are arranged in the region of the edge or of the transition portion of the nozzle body. The transition portion is in particular a portion of the nozzle body in which the latter has a rounding or a zone with a continuous transition between the portion formed as a blind hole and the further portions of the nozzle body recess. The edge or the transition portion may provide the advantage that the high intensity of the turbulence of the fluid can be attained in a particularly simple manner, and said turbulence can be transmitted particularly effectively into the at least one injection opening.

In a further advantageous embodiment, the nozzle body has a further edge or a further transition portion between the portion of the nozzle body recess and the at least one injection opening. The recesses and/or protrusions are arranged in the region of the further edge of the nozzle body. This may provide the advantage that the high intensity of the turbulence of the fluid can be formed directly at the fluid inlet of the at least one injection opening and can thus contribute to particularly small fluid droplets.

In a further advantageous embodiment, the recesses and/or protrusions formed as microstructures have a height or depth of at least approximately 3 μm. With such small heights or depths of the recesses or protrusions, it may be possible in particular for a high intensity of the turbulence of the fluid to be attained already at the further edge or at the further transition portion between the portion of the nozzle body recess and the at least one injection opening.

In a further advantageous embodiment, the recesses and/or protrusions formed as microstructures have a height or depth of at least approximately 18 μm. Such heights or depths of the recesses or protrusions may permit a high intensity of the turbulence of the fluid both in the portion of the nozzle body recess and in the at least one injection opening.

In a further advantageous embodiment, the nozzle assembly has at least two injection openings 24. Here, the recesses and/or protrusions are arranged and formed in a wall of the portion of the nozzle body recess such that a fluid swirl can be generated in each of the injection openings by means of the recesses and/or the protrusions.

The recesses and/or protrusions are formed such that the fluid can be supplied to the injection openings in such a way that swirl formation may be attained in each of the injection openings.

Said arrangement may provide the advantage of reliable swirl formation in the injection openings. It may thereby be possible firstly to attain a reduced axial speed and secondly an additional tangential speed component. The tangential component causes a swirl flow with a low pressure in the swirl axis to form in the injection openings. Under certain flow conditions, said pressure may reach values at which cavitation occurs. The cavitation bubbles arising in the event of cavitation collapse as they exit the injection openings, as a result of which energy from the surface tension of the cavitation bubbles is released, and pressure waves are formed. The combination of the tangential flow component together with the energy of the pressure waves and the surface tension may yield a very fine atomization of the fluid, a broadening of the individual spray cone angles, and therefore a reduced axial penetration depth of the spray.

In a further advantageous embodiment, at least one of the recesses and/or protrusions is assigned to each of the injection openings. This may provide the advantage that only minor modifications to the nozzle body are necessary, and nevertheless reliable swirl formation can be attained in each of the injection openings.

In a further advantageous embodiment, in each case two of the recesses and/or protrusions are assigned to each of the injection openings. It may thereby be possible for fluid to be conducted to the injection openings in each case from two eccentric main flow directions, as a result of which highly effective and reliable swirl formation in the injection openings is possible.

In a further advantageous embodiment, the portion of the nozzle body recess is formed as a blind hole with a blind hole wall and a blind hole base. The injection openings are arranged in the blind hole base. In each case two of the recesses and/or protrusions are assigned to each of the injection openings. One of said recesses and/or protrusions is arranged in the blind hole base, and the other of said recesses and/or protrusions is arranged in the blind hole wall. This may provide the advantage that fluid can be conducted to the injection openings in each case from two opposite directions, and therefore a targeted formation and intensification of fluid vortices in the injection openings may be possible. It may thereby be possible to attain particularly expedient dynamics of the fluid with regard to the formation of swirl in the injection openings.

In a further advantageous embodiment, the recesses are of duct-like form and/or the protrusions are of rod-like form and extend in each case in a longitudinal direction. The longitudinal directions of the recesses and/or protrusions are tangents to the injection openings. This may provide the advantage that very simple production of the recesses and/or protrusions is possible.

In a further advantageous embodiment, the recesses and/or the protrusions are formed so as to be curved toward the injection openings. This may provide the advantage that fluid can be conducted to the injection openings in each case from two opposite directions, and therefore a targeted formation of a predefined direction of rotation of the fluid in the injection openings may be possible. Very stable swirl formation in the injection openings may therefore be possible.

In some embodiments, the recesses and/or protrusions on the nozzle body can be produced in a very simple and cost-effective manner by means of a sintering process.

Other embodiments provide an injection valve having a nozzle assembly as discussed above, and an actuator designed to act on the nozzle assembly.

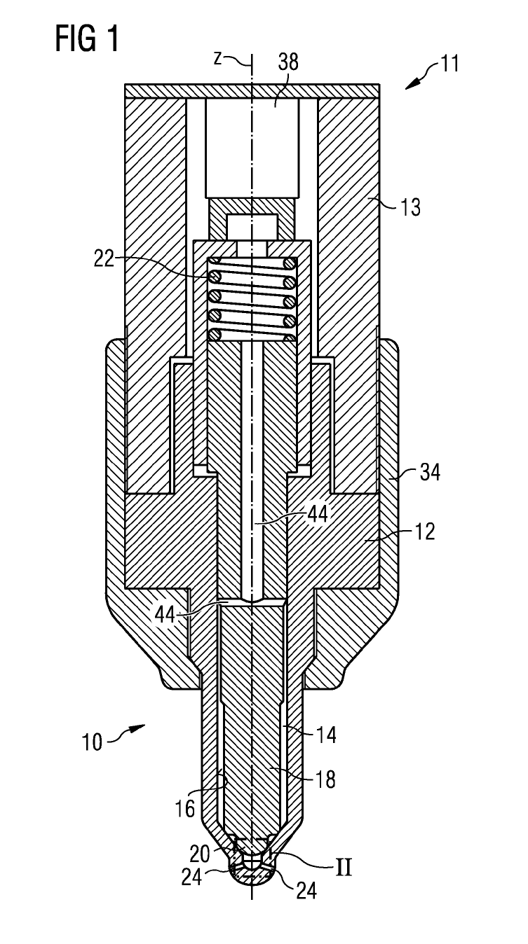

FIG. 1 shows an injection valve having a nozzle assembly 10 and an actuator 11, according to certain embodiments. The actuator 11 functionally interacts with the nozzle assembly 10.

The nozzle assembly 10 has a nozzle body 12, and the actuator has an injector body 13. The nozzle body 12 is fixedly coupled to the injector body 13 by means of a nozzle clamping nut 34. The nozzle body 12 and the injector body 13 thus form a common housing of the injection valve.

The nozzle body 12 has a nozzle body recess 14 with a wall 16. A nozzle needle 18 with a central axis Z is arranged in the nozzle body recess 14, which nozzle needle together with the nozzle body 12 forms the nozzle assembly 10. The nozzle needle 18 has a needle tip 20 on one end.

The nozzle needle 18 is guided in a region of the nozzle body recess 14. Said nozzle needle is also preloaded by means of a nozzle spring 22 such that it prevents a fluid flow through an injection opening 24 arranged in the nozzle body 12 when no other forces are acting on the nozzle needle 18.

The injector body 13 has a recess in which an actuating drive is arranged. The actuating drive 38 is designed as a stroke-type actuating drive and is preferably a piezo actuator which comprises a stack of piezoelectric elements. The piezo actuator changes its axial extent as a function of an applied voltage signal. The actuating drive may however also be designed as some other actuating drive which is known to a person skilled in the art for this purpose and which is known to be suitable, for example as an electromagnetic actuating drive. The actuating drive 38 acts on the nozzle needle 18 via a transmitter such that said nozzle needle can perform an axial movement.

The nozzle spring 22 is supported at one side on a pot base of a pot-shaped body which is mechanically coupled to the actuating drive 38. The nozzle spring 22 bears at the other side against an end surface of the nozzle needle 18. Said nozzle spring is correspondingly preloaded and thus exerts a force acting in the closing direction on the nozzle needle 18.

When the actuating drive 38 is actuated, the nozzle needle 18 is moved in the axial direction from its closed position into its open position, in which it permits the fluid flow through the injection openings 24.

In the nozzle needle 18 there are formed bores 44 which extend through the nozzle needle 18 in a portion at least along a part of its axial extent from its side facing toward the pot-shaped body. In a further portion, the bores 44 are directed radially outward. The fluid, in particular the fuel, can pass through the bores 44 and flows onward through an intermediate chamber between the nozzle needle 18 and the nozzle body 12 to the injection openings 24.

FIG. 2 shows an enlarged illustration of a detail II from FIG. 1 in the region of the needle tip 20 and of the nozzle body 12, according to certain embodiments.

On the wall 16 of the nozzle body recess 14, the nozzle body 12 has a sealing seat 50 which is in the shape of a conical surface. The nozzle needle 18 has a seat region 52 in the region of the needle tip 20. The seat region 52 of the needle tip 20 interacts with the sealing seat 50 of the nozzle body such that the nozzle needle 18, in a closed position, prevents a fluid flow through the at least one injection opening 24 and, in an open position, enables a fluid flow through the at least one injection opening 24. It is preferable for multiple injection openings 24, which may be arranged in the form of an injection hole circle, to be formed in the nozzle body 12.

A portion 56 of the nozzle body recess 14 is formed downstream of the sealing seat 50. The portion 56 of the nozzle body recess 14 is preferably formed as a blind hole. The portion 56 of the nozzle body recess 14 is hydraulically coupled to the injection openings 24. In this way, it is possible for fluid to pass out of the intermediate space between the needle tip 20 and the nozzle body 12 into the portion 56 of the nozzle body recess 14, and finally onward to the injection openings 24.

The portion 56 of the nozzle body recess 14 has a wall 58 which is part of the wall 16 of the nozzle body recess 14. The injection openings 24 furthermore have walls 60.

The nozzle body 12 has an edge or a transition portion 62 between the portion 56, which is preferably formed as a blind hole, and further portions of the nozzle body recess 14, which are in particular formed between the needle tip 20 and the nozzle body 12.

The nozzle body 12 has further edges or further transition portions 64 between the portion 56 of the nozzle body recess 14 and the injection openings 24. It is preferable for each of the further edges or further transition portions 64 to be assigned to one of the injection openings 24.

According to some embodiments, turbulence elements including recesses and/or protrusions formed as microstructures are arranged on one surface region, or on several surface regions, of the nozzle body recess 14, in such a way that a predefined intensity of the turbulence of the fluid in the at least one injection opening 24 can be generated by means of the recesses and/or the protrusions 66, 68, 70, 72, 74 (turbulence elements).

For example, the recesses and protrusions 66 formed as microstructures are formed on the wall 58 of the portion 56 of the nozzle body recess 14. The recesses and protrusions 66 on the wall 58 of the portion 56 preferably have a height or depth of at least approximately 18 μm. With such a height or depth of the recesses and protrusions 66, a high intensity of the turbulence of the fluid may be attained within the portion 56 of the nozzle body recess 14. Said turbulence of the fluid can lead to a spray pattern with an advantageous spatial distribution and small fluid droplets being attained downstream of the injection openings 24.

Furthermore, the wall 58 of the portion 56 of the nozzle body recess 14 has further recesses and protrusions 68, which are arranged on the edge 62 of the nozzle body 12. The recesses and protrusions 68 preferably have a height or depth of at least approximately 18 μm. It may thereby be possible for a high intensity of the turbulence of the fluid in the at least one injection opening 24 to be produced in the portion 56 of the nozzle body recess 14. It may thereby be possible to attain a good distribution of the droplets of the fluid, and a spray pattern with an advantageous spatial distribution, at the outlet of the injection openings 24.

The wall 58 of the portion 56 of the nozzle body recess 14 has further recesses and protrusions 70, which are arranged at the further edge or at the further transition portion 64 between the portion 56, which is formed as a blind hole, of the nozzle body recess 14 and the injection openings 24. The recesses and protrusions 70, which are formed as microstructures, preferably have a height or depth of at least approximately 3 μm. It may thereby be possible to attain a high intensity of the turbulence of the fluid at the inlet to the injection openings 24 and furthermore in the injection openings 24.

In a further embodiment, further recesses and protrusions 72 are formed on the needle tip 20. The recesses and protrusions 72 formed as microstructures may have a height or depth of at least 18 μm to attain a high intensity of the turbulence in the portion 56 of the nozzle body recess 14 and, as a result, in the injection openings 24. It may thereby be possible to attain very small droplet sizes as the fluid emerges at the injection openings 24.

Further recesses and protrusions 74 may be arranged in the wall 60 of the injection opening 24 and formed as microstructures. The recesses and protrusions 74 may have a height or depth of at least approximately 3 μm to attain a high intensity of the turbulence of the fluid in the injection openings 24.

The recesses and protrusions 66, 68, 70, 72, 74 may have a regular shape.

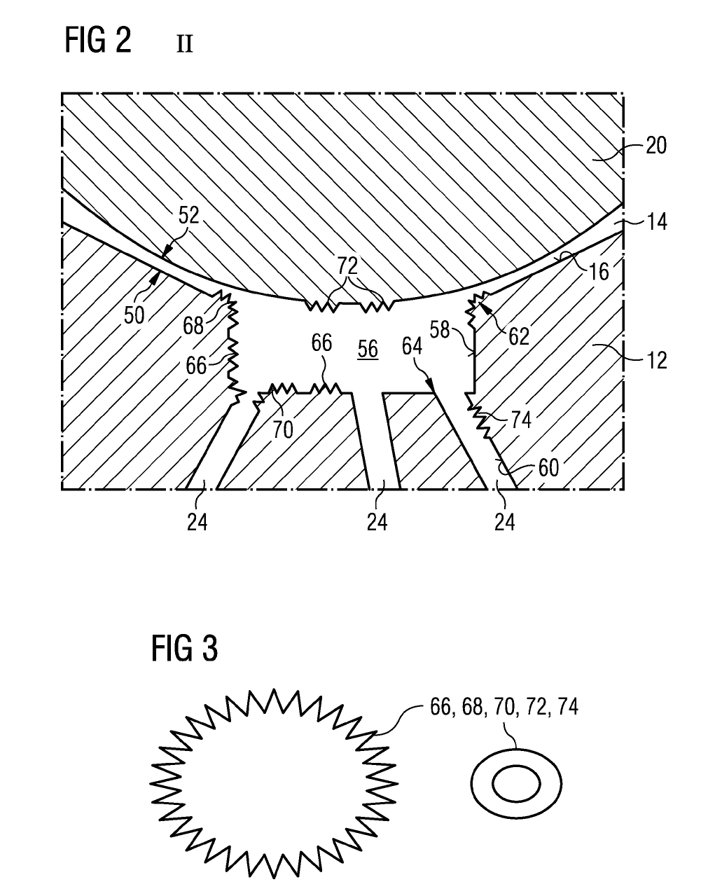

The recesses and protrusions 66, 68, 70, 72, 74 may be of annular design. This may permit simple production of the recesses and protrusions (FIG. 3).

In a further embodiment, the recesses and protrusions 66, 68, 70, 72, 74 are of zig-zag shaped design. It may thereby be possible to attain a particularly high intensity of turbulence of the fluid in the injection openings 24 (FIG. 3).

In a further embodiment, the recesses and protrusions 66, 68, 70, 72, 74 have an irregular shape.

In a further embodiment, the recesses and protrusions 66, 68, 70, 72, 74 formed as microstructures are formed as surface roughness.

The recesses and protrusions 66, 68, 70, 72, 74 formed as microstructures may permit a suitable formation of the surface roughness of the needle tip 20 and/or of the wall 16 of the nozzle body recess 14 and/or of the wall 60 of the injection opening 24. It may thereby be possible for flow energy of the fluid to be converted into vortices of a turbulent flow, in order thereby to attain the formation of small droplets of the fluid at the outlet of the injection openings 24. It may thereby be possible for the length of the spray cone to be made small and for the width of the spray cone to be made large.

Furthermore, cavitation in the injection openings 24 can be attained by means of the recesses and protrusions 70, 74 formed as microstructures. In particular if the injection valve is used in an internal combustion engine, this permits a high quality of the combustion of the fuel. In particular if multiple injection openings 24 are used, this can lead to an improvement in a stratified-charge combustion mode in a cylinder of the internal combustion engine.

The production of a predefined surface roughness of the needle tip 20 and/or of the wall 16 of the nozzle body recess 14 and/or of the wall 60 of the injection opening 24 can be realized, e.g., by means of a sintering process during the production process of the nozzle needle 18 and/or of the nozzle body 12. This may yield a very cost-effective solution for the formation of the recesses and protrusions in the needle tip 20 and/or in the walls 16, 58, 60 of the nozzle body 12.

As a result of the fact that cavitation is effected in the injection openings 24, residues which may be deposited on the walls 60 of the injection openings 24 during the combustion of a fuel may be eliminated in a simple manner.

As a result of the attainment of a predefined intensity of the turbulence of the fluid, kinetic energy can be converted from the main flow of the fluid into swirling of the fluid. The turbulence of the fluid at the outlet of the injection openings 24 can therefore be high. It may thus be possible to attain very good droplet formation of the fluid. In this way, it may be possible for the length of the spray jet to be small and for the width of the spray cone to be large.

The formation of the recesses and protrusions 66, 68, 72 with a height or depth of at least approximately 18 μm may generally lead, if the injection valve is used in an internal combustion engine, to a very high intensity of the turbulence of the fluid in the injection openings 24. In the region of the further edge or of the further transition region 64 of the nozzle body 12 and in the walls 60 of the injection openings 24, it may be advantageous for the recesses and protrusions 70, 74 formed as microstructures to have a height or depth of at least approximately 3 μm. Owing to the generally small diameter of the injection openings 24, it may be possible even with such small heights and depths of the recesses and protrusions 70, 74 to attain a high intensity of the turbulence of the fluid in the injection openings 24.

In general, with the recesses and protrusions 66, 68, 70, 72, 74 formed as microstructures, it may be possible to attain a very high intensity of the turbulence of the fluid in the injection openings 24 and a small droplet size and a well-formed spray pattern of the fluid at the outlet of the injection openings 24. Here, a high mass flow of the fluid and high stability of the mass flow of the fluid can be attained.

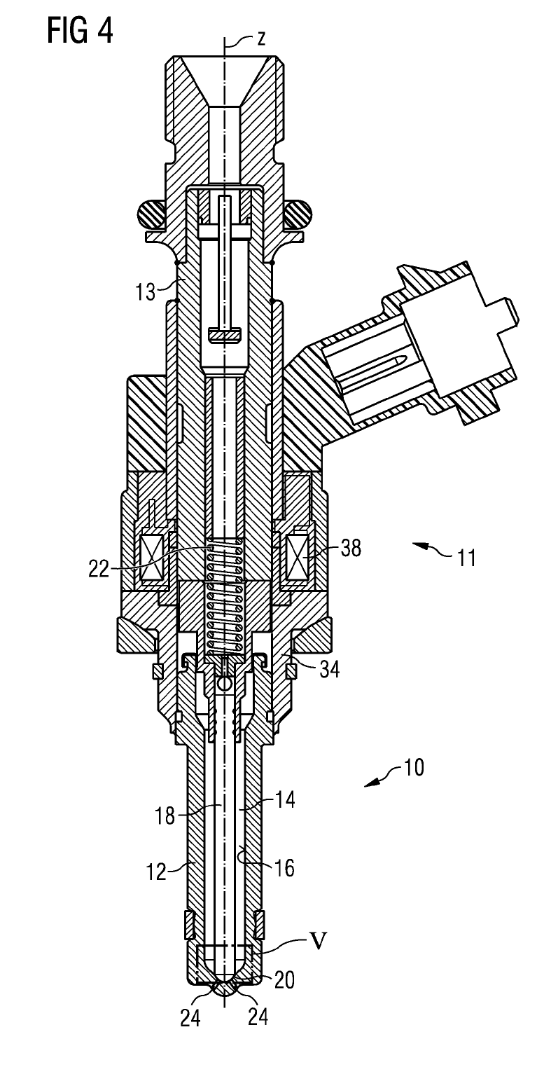

FIG. 4 shows a further example of an injection valve with a nozzle assembly 10 and an actuator 11, according to certain embodiments. Here, too, the actuator 11 functionally interacts with the nozzle assembly 10.

The nozzle assembly 10 has a nozzle body 12, and the actuator has an injector body 13. The nozzle body 12 is fixedly coupled to the injector body 13 by means of a nozzle clamping nut 34. The nozzle body 12 and the injector body 13 form a common housing of the injection valve.

The nozzle body 12 has a nozzle body recess 14 with a wall 16. A nozzle needle 18 with a central axis Z is arranged in the nozzle body recess 14, which nozzle needle together with the nozzle body 12 forms the nozzle assembly 10. The nozzle needle 18 has a needle tip 20 on one end. The nozzle needle 18 is guided in a region of the nozzle body recess 14 and is preloaded by means of a nozzle spring 22.

Injection openings 24 are arranged in the nozzle body 12 preferably close to the needle tip 20. In a region surrounding the injection openings 24, the nozzle body 12 may be composed of a sintered metal. In the nozzle body 12 there are preferably formed multiple injection openings 24, which may form an injection hole circle.

The injector body 13 has a recess in which an actuating drive is arranged. The actuating drive 38 is designed as a stroke-type actuating drive. The actuating drive 38 acts on the nozzle needle 18 such that the latter can perform an axial movement.

The nozzle spring 22 exerts a force acting in the closing direction on the nozzle needle 18, such that, when no other forces are acting on the nozzle needle 18, said nozzle needle prevents a fluid flow through the multiple injection openings 24 arranged in the nozzle body 12. When the actuating drive 38 is operated, the nozzle needle 18 is moved in the axial direction from its closed position into its open position, in which it enables the fluid flow through the injection openings 24.

FIG. 5 shows an enlarged illustration of a detail V from FIG. 4 in the region of the needle tip 20 and of the nozzle body 12, according to certain embodiments.

On the wall 16 of the nozzle body recess 14, the nozzle body 12 has a conical sealing seat 50. The nozzle needle 18 has, in the region of the needle tip 20, a seat region 52 which interacts with the sealing seat 50 of the nozzle body 12 in such a way that the nozzle needle 18, in a closed position, prevents a fluid flow through the at least one injection opening 24, and in an open position, permits a fluid flow through the at least one injection opening 24.

Downstream of the sealing seat 50, a portion 56 of the nozzle body recess 14 is formed which is hydraulically coupled to the injection openings 24. In this way, the fluid can pass from the intermediate space between the needle tip 20 and the nozzle body 12 into the portion 56 of the nozzle body recess and finally onward to the injection openings 24. The portion 56 of the nozzle body recess 14 has a wall 58 which is a part of the wall 16 of the nozzle body recess 14. The portion 56 of the nozzle body recess 14 is formed as a blind hole. The blind hole has a blind hole wall 59 and a blind hole base 61. The injection openings 24 are arranged in the blind hole base 61.

The nozzle body 12 has an edge 64 between the portion 56, which is formed as a blind hole, and further portions of the nozzle body recess 14, which are in particular formed between the needle tip 20 and the nozzle body 12. Recesses 66 and/or protrusions 68 are arranged in the wall 58 of the portion 56 of the nozzle body recess 14.

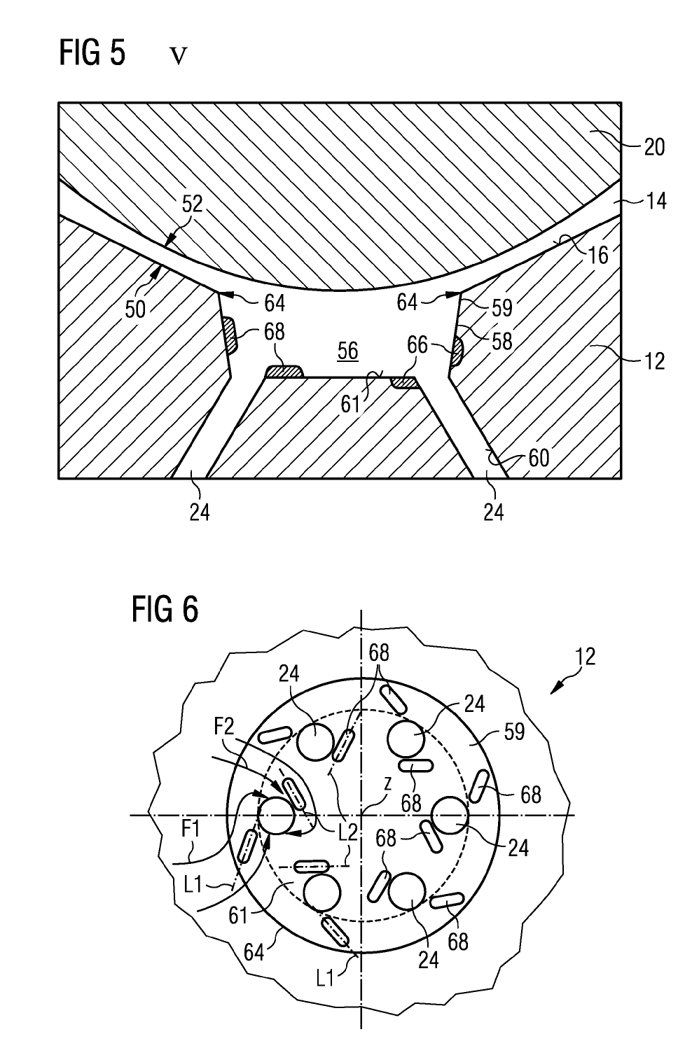

FIG. 6 illustrates the nozzle body 12 in the region of the portion 56 of the nozzle body recess 14 in an example embodiment with the protrusions 68. In the embodiment shown here, the nozzle body 12 has six injection openings 24, which are arranged in the blind hole base 61 at angular intervals of 60° relative to one another about the central axis Z. In further embodiments, the number of injection openings 24 may also assume some other value. Each of the injection openings is assigned in each case two protrusions 68. One of the protrusions 68 is arranged in the blind hole base 61, and the other of the protrusions 68 is arranged in the blind hole wall 59. The protrusions 68 are of rod-shaped form. The protrusions 68 arranged in the blind hole wall 59 extend in each case in the longitudinal direction L1. The protrusions 68 arranged in the blind hole base 61 extend in each case in longitudinal directions L2. The longitudinal directions L1, L2 of the protrusions 68 are tangents to the injection openings 24.

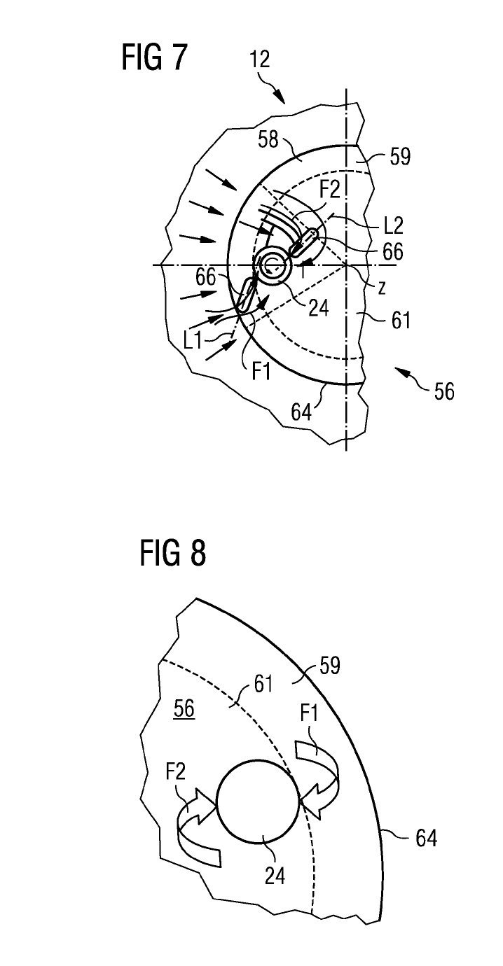

In the example embodiment of the nozzle assembly 10 shown in FIG. 7, the recesses 66 are arranged in the portion 56 of the nozzle body recess 14. Each of the injection openings 24 is assigned to two of the recesses 66. In each case one of the recesses 66 is arranged in the blind hole base 61, and another of the recesses 66 is arranged in the blind hole wall 59. The recesses 66 in the blind hole wall 59 extend in each case in longitudinal directions L1, and the recesses 66 in the blind hole base 61 extend in each case in longitudinal directions L2. The longitudinal directions L1, L2 of the recesses 66 are tangents to the injection openings 24.

FIG. 8 shows a diagrammatic illustration of the swirl formation at the injection opening 24, according to certain embodiments. A first fluid flow F1, which passes over the edge into the portion 56 of the nozzle body recess 14, is conducted to the injection opening 24 by means of the recess or protrusion 68 (not illustrated here) arranged in the blind hole wall 58, and in the process arrives at a tangent to the injection opening 24. A further fluid flow F2 passes over the edge 64 likewise into the portion 56 of the nozzle body recess 14, and is diverted tangentially to the injection opening 24 by the other recess 66 or protrusion 68 (not illustrated here) in the blind hole base 61. As a result of the substantially oppositely intensifying movement of the fluid flows F1, F2, fluid swirl with high stability can form very rapidly at the injection opening 24. The fluid swirl passes in a whirling manner through the injection opening 24. The lower axial speed of the particles in the fluid relative to the greater tangential speeds of the fluid flows F1, F2 at the inlet to the injection openings 24 and in the injection openings 24 themselves may permit fine atomization of the fluid and a large spray angle at the outside of the nozzle body 12. By means of the assignment of in each case two recesses 66 or protrusions 68 to each of the injection openings 24, it may be possible even in an injection valve with a multiplicity of injection openings 24, that is to say in a multi-hole nozzle, to attain a finer atomization of the fluid and a larger spray angle at the outlet of the injection openings 24. If the injection valve is used in particular in an internal combustion engine, it may be possible in this way to attain a good distribution of the fuel in the air sucked in by the internal combustion engine, and in particular a stratification of the air/fuel mixture in a combustion chamber of the internal combustion engine, and wetting of the surfaces in the combustion chamber can be reduced, minimized or eliminated.

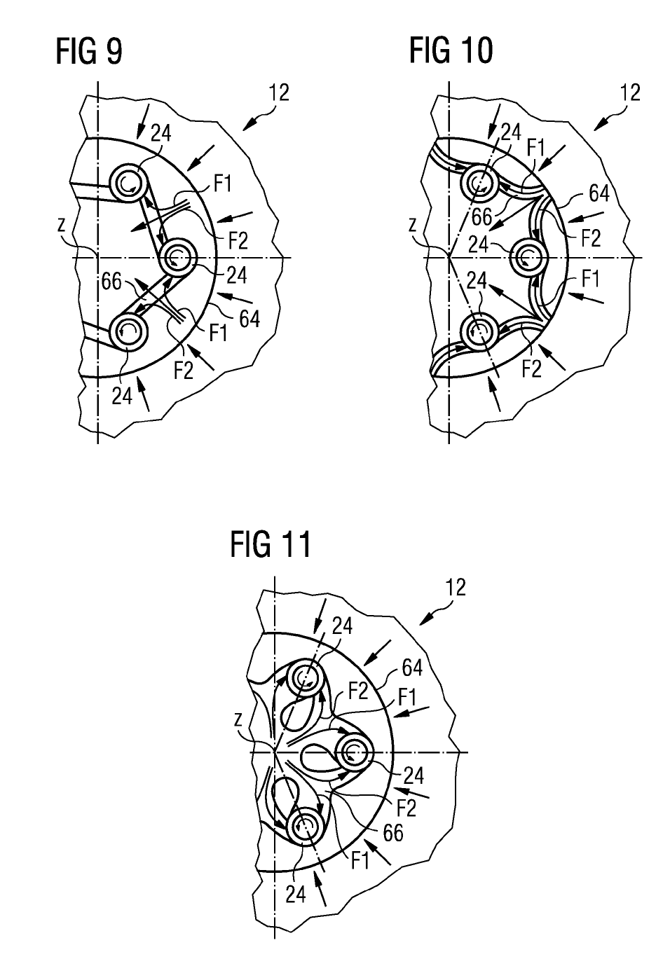

In the example embodiment of FIG. 9, the recesses 66 in the wall 58 are arranged in each case between two injection openings 24. It may thereby be possible for fluid flows F1, F2 to firstly pass over the edge 64 into the portion 56, which is formed as a blind hole, of the nozzle body recess 14, and finally to be diverted tangentially in opposite directions to the injection openings 24 by means of the recesses 66.

In the example embodiment shown in FIG. 10, the recesses 66 are formed in an arc from the edge 64 to the injection openings 24, such that the fluid flows F1, F2 can pass directly from the edge 64 to the injection openings 24 tangentially in opposite directions.

In the example embodiment shown in FIG. 11, the fluid flows F1, F2 can pass tangentially in opposite directions to the injection openings 24 via the recesses 66 from a central region of the portion 56 of the nozzle body recess 14 close to the central axis Z. This may be particularly preferable if the portion 56, which is formed as a blind hole, of the nozzle body recess 14 has a large depth, such that the fluid flows F1, F2 firstly pass into the center of the portion 56, which is formed as a blind hole, of the nozzle body recess 14 close to the central axis Z, and are then conducted to the injection openings 24.

The invention is not restricted to the exemplary embodiments specified. In particular, it is possible for the features of different exemplary embodiments to be combined with one another, and therefore such arrangements are also encompassed by the invention.

What is claimed is:

1. A nozzle assembly for an injection valve, comprising:
a nozzle body having a nozzle body recess and at least one injection opening, wherein the nozzle body recess is configured for hydraulically coupling to a high-pressure circuit of a fluid, and the injection opening is hydraulically coupled to the nozzle body recess, and
at least one nozzle needle arranged in an axially movable manner in the nozzle body recess, and having a central axis and a needle tip,
wherein a sealing seat is formed on a wall of the nozzle body recess and a seat region is formed on the needle tip,
wherein the seat region interacts with the sealing seat such that the nozzle needle, in a closed position, prevents a fluid flow through the at least one injection opening and, in an open position, permits the fluid flow through the at least one injection opening,
wherein downstream of the sealing seat and the seat region, protrusions turbulence elements formed as microstructures are arranged on at least one of (a) the needle tip and (b) at least one surface region of the nozzle body recess, such that the recesses and/or protrusions generate a predefined intensity of turbulence of the fluid in the at least one injection opening, wherein the turbulence elements include at least one of recesses and protrusions.

2. The nozzle assembly of claim 1, wherein the at one surface region comprises a wall of the nozzle body or a wall of the at least one injection opening.

3. The nozzle assembly of claim 1, wherein the turbulence elements are annular.

4. The nozzle assembly of claim 1, wherein the turbulence elements have a zig-zag shaped structure.

5. The nozzle assembly of claim 1, wherein the turbulence elements are parts of a predefined surface roughness of at least one of the needle tip, the wall of the nozzle body recess, and the wall of the at least one injection opening.

6. The nozzle assembly of claim 1,
wherein, downstream of the sealing seat a portion of the nozzle body recess is hydraulically coupled to the at least one injection opening, and
wherein the surface region of the nozzle body recess is a wall of the portion of the nozzle body recess.

7. The nozzle assembly of claim 6,
wherein the portion of the nozzle body recess is formed as a blind hole,
wherein the nozzle body has an edge or a transition portion between the portion formed as a blind hole and further portions of the nozzle body recess, and
wherein the turbulence elements are arranged in the region of the edge or of the transition portion of the nozzle body.

8. The nozzle assembly claim 6,
wherein the nozzle body a further edge or a further transition portion between the portion of the nozzle body recess and the at least one injection opening, and
wherein the turbulence elements are arranged in the region of the further edge or of the further transition portion of the nozzle body.

9. The nozzle assembly of claim 1, wherein the turbulence elements formed as microstructures have a height or depth of at least approximately 3 μm.

10. The nozzle assembly of claim 1, wherein the turbulence elements formed as microstructures have a height or depth of at least approximately 18 μm.

11. The nozzle assembly of claim 6, having at least two injection openings, wherein at least one of the turbulence elements is assigned to each of the injection openings.

12. The nozzle assembly of claim 11, wherein in two of the turbulence elements are assigned to each of the injection openings.

13. The nozzle assembly of claim 6,
wherein the portion of the nozzle body recess is formed as a blind hole with a blind hole wall and a blind hole base,
wherein the injection openings are arranged in the blind hole base, and two of the turbulence elements are assigned to each of the injection openings, and
wherein one of said turbulence elements is arranged in the blind hole base, and the other of said turbulence elements is arranged in the blind hole wall.

14. The nozzle assembly of claim 6,
wherein the turbulence elements comprise recesses having a duct-like form or protrusions having a rod-like form,
wherein each turbulence element extends in a longitudinal direction, and
wherein the longitudinal directions of the turbulence elements are tangent to the injection openings.

15. The nozzle assembly of claim 6, wherein the turbulence elements are curved toward the injection openings.

16. An injection valve, comprising:
a nozzle assembly including:
a nozzle body having a nozzle body recess and at least one injection opening, wherein the nozzle body recess is configured for hydraulically coupling to a high-pressure circuit of a fluid, and the injection opening is hydraulically coupled to the nozzle body recess, and
at least one nozzle needle arranged in an axially movable manner in the nozzle body recess, and having a central axis and a needle tip,
wherein a sealing seat is formed on a wall of the nozzle body recess and a seat region is formed on the needle tip,
wherein the seat region interacts with the sealing seat such that the nozzle needle, in a closed position, prevents a fluid flow through the at least one injection opening and, in an open position, permits the fluid flow through the at least one injection opening,
wherein downstream of the sealing seat and the seat region, turbulence elements formed as microstructures are arranged on at least one of the needle tip and a surface region of the nozzle body recess, such that the recesses and/or protrusion generate a predefined intensity of turbulence of the fluid in the at least one injection opening, wherein the turbulence elements include at least one of recesses and protrusions, and
an actuator configured to act on the nozzle assembly.

17. The injection valve of claim 16, wherein the turbulence elements are annular shaped.

18. The injection valve of claim 16, wherein the turbulence elements have a zig-zag shaped structure.

19. The injection valve of claim 16,
wherein downstream of the sealing seat, a portion of the nozzle body recess is hydraulically coupled to the at least one injection opening, and
wherein the surface region of the nozzle body recess is a wall of the portion of the nozzle body recess.

20. The injection valve of claim 16,
wherein the turbulence elements comprise recesses having a duct-like form or protrusions having a rod-like form,
wherein each turbulence element extends in a longitudinal direction, and
wherein the longitudinal directions of the turbulence elements are tangent to the injection openings.
